(19) United States
(12) Patent Application Publication
(10) Pub. No.: US 2008/0270112 A1
(43) Pub. Date: Oct. 30, 2008

(54) Translation evaluation device, translation evaluation method and computer program

(75) Inventor: Sayori Shimohata, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/078,121

(22) Filed: Mar. 27, 2008

(30) Foreign Application Priority Data
Apr. 27, 2007 (JP) 2007-119450

(51) Int. Cl. G06F 17/28

(52) U.S. Cl. 704/3

(57) ABSTRACT

A translation evaluation device that evaluates the quality of a translation of an original text comprises a parallel translation storage unit (320) in which basic original texts (321) used as a basis for translation evaluation and correlated model translations (322) used as models for translation of the basic original texts are stored, an evaluation item input unit (310) to which a specific evaluation item (311) to be used for translation evaluation is input, a parallel translation extraction unit (225) that extracts from the parallel translation storage unit (320) a basic original text containing the evaluation item and a model translation corresponding to the basic original text, and a evaluation processor (240) that evaluates the quality of translation results (333) constituted with a translated text of the basic original text and input thereto, by comparing the translation results with the model translation (332) corresponding to the basic original text.

### CROSS REFERENCE TO RELATED APPLICATIONS

The disclosure of Japanese Patent Application No. JP 2007-119450 filed on Apr. 27, 2007 is incorporated herein by reference in its entirety.

### BACKGROUND OF INVENTION

1. Field of the Invention

The present invention relates to a translation evaluation device, a translation evaluation method and a computer program. More specifically, it relates to a translation evaluation device, a translation evaluation method and a computer program with which the translation ability level of a human translator, a machine translation system or the like and the quality of the text translated by the human translator, the machine translation system or the like can be automatically evaluated.

2. Description of the Related Art

The translation ability of human translators and machine translation systems and the quality of translations provided by human translators and machine translation systems are evaluated either subjectively by a human evaluator or automatically and objectively by a machine based upon translations of test texts in the related art so as to quantitatively and effectively measure translation abilities.

Methods that may be adopted when evaluating the translation ability and the translation quality through subjective grading by a human evaluator include the method disclosed in non-patent reference literature 1, “Sumita, E et al.: “Solutions to Problems Inherent in Spoken-language Translation: the ATR-MATRIX Approach” Proc. MT Summit VII pp. 229-235 (1999)”. In this evaluation method, the evaluator subjectively ranks the translation ability or the translation quality as A, B, C or D in conformance to predetermined evaluation criteria. The grades awarded through this method may include, for instance, A (perfect) for a grammatically correct translation that provides all the information present in the original, B (fair) for a reasonably comprehensible translation which may not contain some nonessential information present in the original and may include grammatical errors, C (adequate) for an incomplete but still somewhat comprehensible translation and D (incoherent) for an erroneous translation missing essential information.

In a machine evaluation method adopted to evaluate the target automatically and objectively by a machine, the machine (computer program) may compare the translation (evaluation target translation) of a test text (evaluation original) with a model translation (perfect translation) and indicate the quality of the evaluation target translation as a numerical value by calculating the similarity factor representing the level of similarity between the evaluation target translation and the model translation. In such a method, the total sum of the translation quality numerical values or the average of the translation quality numerical values is calculated and output as the overall evaluation value.

The evaluation index BLEU used in non-patent reference literature 2, “Kishore Papineni, Salim Roukos, Todd Ward and Wei-Jing Zhu, 2002, BLEU: A Method for Automatic Evaluation of Machine Translation. In the proceedings of ACL-2002, pages 311-318”, for instance, indicating the similarity factor representing the degree of similarity between the evaluation target translation (translated text) and the model translation (reference translation), is calculated as expressed in (1) and (2) below, based upon the numbers of n-gram matches. The “n-gram” indicates a string constituted with n consecutive items. For instance, a “word n-gram” is a string constituted with n consecutive words, whereas a “character n-gram” is a character string constituted with n characters.

$$\begin{matrix}BLEU = {BP}_{BLEU} \times exp ( {\sum }_{n = 1}^{N} {w}_{n} log {p}_{n} ) & Equation 1 \\ {p}_{n} = \frac{{\sum }_{i} \begin{matrix}( number of n \text{-} gram matches \\ between translation i and reference translation i )\end{matrix}}{{\sum }_{i} ( total number of n \text{-} grams in translation i )} & Equation 2\end{matrix}$$

Pn represents the n-gram match rate calculated by comparing the translation with the reference translation based upon an evaluation corpus having stored therein a plurality of pairs each made up with a translation and a reference translation. A BLEU score is calculated as a geometric mean for 1-gram through N-gram by using the Pn thus calculated. N is normally 4. 1-gram is an index that indicates the level of accuracy of the translation of the individual words, whereas a higher-order n-gram is an index that indicates the level of overall fluency of the translation. The BLEU score calculated as expressed in expression 1 is an integrated index incorporating the two types of indices. It is to be noted that BPbleu represents a penalty given when the translated text is shorter than the reference translation and it assumes a value of 1 if the translated text is longer than the reference translation, whereas it assumes a value; e(1−r/c) (r indicates the reference translation length and c represents the translated text length) if the translated text has a length equal to or smaller than that of the reference translation. The BLEU score is thus provided as a real number in the range of 0˜1, and a translated text with a higher BLEU score is judged to be a higher-quality translation.

In addition, the evaluation index NIST score used in non-patent reference literature 3, “George Doddington 2002. Automatic Evaluation of Machine Translation Quality Using n-Gram Co-Occurrence Statistics. In the proceedings of the HLT Conference, San Diego, Calif.”, is calculated as expressed in (3) and (4) below based upon the number of n-gram matches indicating the level of similarity between the evaluation target translation and the reference translation, as is the BLEU score described above.

$$\begin{matrix}NIST = {BP}_{NIST} \times {\sum }_{n = 1}^{N} \frac{{\sum }_{i} ( {\sum }_{\begin{matrix}{w}_{1} … {w}_{n} common in translation text \\ i and reference translation i\end{matrix}} Info ( {w}_{1} … {w}_{n} ) )}{{\sum }_{i} ( total number of n \text{-} grams in translated text i )} & Equation 3 \\ Info ( {w}_{1} … {w}_{n} ) = {log}_{2} \frac{number of {w}_{1} … {w}_{n - 1} in evaluation corpus}{number of {w}_{1} … {w}_{n} in evaluation corpus} & Equation 4\end{matrix}$$

The NIST score is provided as a real number equal to or greater than 0, and a translated text with a higher NIST score is judged to be a higher-quality translation. N is normally 5. It is to be noted that BPnist, which is similar to BPbleu, takes on the value of 1 if the length of the translated text is greater than that of the reference translation. The major difference between the NIST score and the BLEU score is that the NIST score is calculated by weighting the individual n-grams based upon the volume of information. Under normal circumstances, a greater volume of information is carried in a content word string than in a functional word string and thus, a higher score tends to be awarded when the translation of content words is accurate. In other words, the NIST score is an automatic evaluation score calculated by placing greater importance on the accuracy of the translation of words rather than the correctness of the word order in the translated text.

However, the efficiency and the quality of an evaluation provided through subjective grading by a human evaluator are greatly affected by the skills of the evaluator. In addition, there is a concern with regard to this evaluation method that the optimal evaluation indices cannot be set with ease and that even when a translated text is evaluated based upon uniform evaluation indices, the evaluation results are bound to vary from evaluator to evaluator.

In the machine evaluation method adopted to evaluate the target translation automatically and objectively, the quality of the translated text provided by, for instance, a machine translation system, is evaluated based upon a specific combination of the evaluation original text and a model translation of the evaluation original text (hereafter may also be referred to as “evaluation set”). For this reason, the method is not ideal for applications in which the performance level of the machine translation system is evaluated for system upgrade, e.g., when revising the translation dictionary used in the machine translation system or improving a translation algorithm in the machine translation system, or for development of a system with new functions. For instance, when verifying an improvement in the system performance following registration of a new word in the technical term dictionary or a modification of a translation algorithm in the system, grammatical rules and the like corresponding to the registered word or the modified algorithm must be contained in the evaluation set. However, no special consideration, such as preparing the evaluation set in correspondence to specific purposes of evaluation, is taken in the evaluation method in the related art and thus, there is a concern that the method fails to efficiently provide an optimal evaluation for system performance verification.

### SUMMARY OF THE INVENTION

The present invention having been completed by addressing the issues discussed above, provides a translation evaluation device, a translation evaluation method and a computer program, with which the translation performance or the translation ability can be accurately and efficiently evaluated.

According to an embodiment of the present invention, there is provided a translation evaluation device that evaluates the quality of a translation of an original text. The translation evaluation device comprises a parallel translation storage unit in which model translations are stored each in correlation with a basic original text used as a translation evaluation basis, an evaluation item input unit to which a specific evaluation item to be used for translation evaluation is input, a parallel translation extraction unit that extracts from the parallel translation storage unit a basic original text containing the evaluation item and a model translation corresponding to the basic original text containing the evaluation item, and a translation evaluation unit that evaluates the quality of translation results, constituted with a translated text of the basic original text containing the evaluation item and input thereto by comparing the translation results with the model translation corresponding to the basic original text containing the evaluation items.

In the translation evaluation device adopting the structure described above, a basic original text containing a specific evaluation item to be used in the translation evaluation and the model translation corresponding to the basic original text (evaluation set) are extracted, a translation of the basic original text is input and the quality of the translation is evaluated through comparison of the translation and the model translation. Since the translation results obtained by translating the basic original text corresponding to the specific evaluation item are evaluated as a specific evaluation target, an optimal evaluation can be efficiently provided for translation performance verification or translation ability verification.

The evaluation item may include information related to at least one grammatical rule (e.g., information related to a word type or a conjugation) and/or character string information constituted with a character string corresponding to at least one word (e.g., a word or a sentence). In addition, evaluation items may be input one at a time or they may be input in a batch in an evaluation item data file.

The evaluation items each may include information related to at least one grammatical rule.

By using the evaluation items each containing information related to at least one grammatical rule, an optimal evaluation can be provided efficiently for translation performance verification following, for instance, a modification of a translation algorithm related to a grammatical rule relevant to a specific word type, e.g., a noun or a passive verb, or relevant to a specific conjugation form such as the present progressive form or the past tense form. In addition, if the evaluation subject is a human translator, his translation ability can be checked in correspondence to individual grammatical rules.

The evaluation items may each include character string information constituted with a character string corresponding to at least one word.

In this case, since the evaluation items each include character string information constituted with a character string corresponding to at least one word, an optimal evaluation can be provided with efficiency for purposes of system performance verification after, for instance, registering a dictionary containing words, sentences and the like related to a specific field of expertise such as engineering or science. In addition, if the evaluation subject is a human translator, the translation skills (vocabulary) of the translator in that particular field of expertise can be checked.

If a basic original text containing the specific evaluation item cannot be extracted from the parallel translation storage unit, the parallel translation extraction unit may regard a word constituting part of the evaluation item as an evaluation item and may extracts from the parallel translation storage unit a basic original text containing the evaluation item and the model translation corresponding to the basic original text containing the evaluation item.

In this case, if the evaluation item contains character string information constituted with a character string corresponding to at least two words and a basic original text containing all the words constituting the evaluation item cannot be extracted, a word constituting part of the evaluation item is designated as a new evaluation item and a basic original text containing the newly designated evaluation item and the corresponding model translation are extracted. As a result, even when the evaluation item is constituted with a number of words and a basic original text containing all the words constituting the evaluation item cannot be extracted, a basic original text containing at least one of the words is extracted and the quality of the translation is evaluated by comparing the translation of the basic original text with the model translation of the basic original text. It is to be noted that the word constituting part of the initial evaluation item and selected as the new evaluation item may be a single word or a combination of a plurality of words selected based upon the order in which the individual words constituting the initial evaluation item are strung together or selected by reorganizing the word order.

In addition, the translation evaluation device may further comprise a morphological analysis unit that morphologically analyzes the evaluation item and the basic original text, and in such a case, the parallel translation extraction unit may extract a basic original text containing morphological information identical to morphological information carried in an evaluation item and the model translation corresponding to the basic original text containing the morphological information identical to the morphological information in the evaluation item.

In this case, the evaluation items containing character string information and the basic original texts are morphologically analyzed and a basic original text containing morphological information identical to morphological information carried in a specific evaluation item and the corresponding model translation are extracted. Since the translation results obtained by translating the basic original text corresponding to the morphological information in the evaluation item are evaluated, an optimal evaluation can be provided efficiently for system performance verification.

The term “morphological analysis” refers to an analysis method adopted in linguistics whereby a given phrase is broken down to “elements” constituting the smallest units of phrase parts that remain unchanged or un-conjugated. In addition, the term “morphological information” refers to information indicating a word constituting an “element”, which may be character string information or grammar rule information related to grammar such as a word type or a conjugation form.

The translation evaluation device may further comprise a syntax analysis unit that executes syntax analysis of the evaluation item and basic original text and in such a case, the parallel translation extraction unit may extract a basic original text containing syntax structure information identical to syntax structure information in an evaluation item and the model translation corresponding to the basic original text containing the syntax structure information identical to that in the evaluation item.

In this case, evaluation items containing character string information and basic original texts undergo syntax analysis and a basic original text containing information indicating a syntax structure identical to the syntax structure in a specific evaluation item and the corresponding model translation are extracted. Since the translation results obtained by translating the basic original text containing the syntax structure information corresponding to the syntax structure information in the evaluation item are evaluated, an optimal evaluation can be provided efficiently for system performance verification.

The term “syntax analysis” in this context refers to an analysis method whereby the structures of words/phrases constituting a sentence are grammatically analyzed. Through this syntax analysis, the endpoint of a given clause or the relationship between a preceding clause and a succeeding clause is deduced based upon the positions of individual words in the sentence or the order in which the words are strung in the sentence. The “syntax structure information” refers to information indicating the structures of words/phrases constituting the sentence, which may be information indicating, for instance, the word type of a given word constituting a specific character string or information indicating the specific position at which the particular type of word is placed.

The number of words constituting the basic original text to be extracted for the translation evaluation may be entered at the evaluation item input unit and, in such case, the parallel translation extraction unit may extract a basic original text containing the evaluation item and constituted with words, the number of which matches the number of words having been input and the model translation corresponding to the basic original text containing the evaluation item and constituted with words, the number of which matches the number of words having been input.

In the translation evaluation device adopting the structure described above, a basic original text containing the evaluation item which includes character string information, grammar rule information or the like and constituted with words, the number of which matches the number having been set, and the corresponding model translation are extracted. Since the optimal number of words can be set in correspondence to specific purposes of evaluation by, for instance, setting a smaller number of words when evaluating the accuracy of the translation of the individual words or setting a greater number of words when evaluating the fluency of the translation of a sentence, the optimal basic original text and model translation to be used in the comparison can be extracted efficiently.

In addition, evaluation items may be input to the evaluation item input unit as an evaluation item data file containing a plurality of evaluation items.

In this case, evaluation items are input in the evaluation item data file and thus, a plurality of evaluation items can be input in a batch. Furthermore, an optimal evaluation can be provided efficiently for system performance verification of a plurality of systems based upon common evaluation items.

In the parallel translation storage unit, morphological information and/or syntax structure information related to each basic original text may be stored in correlation to the particular basic original text.

Since the morphological information and/or the syntax structure information for the basic original text is stored in correlation to the basic original text, the need to morphologically analyze and/or syntactically analyze the basic original text during translation evaluation is eliminated.

The translation evaluation unit may compare a plurality of sets of translation results obtained by translating a basic original text containing an evaluation item with the model translation corresponding to the basic original text containing the evaluation item.

In such a case, the translation results provided by a plurality of systems with different specifications or provided by a system with pre-update specifications and a system with updated specifications for a basic original text containing an evaluation item are compared with the corresponding model translation and, as a result, an optimal evaluation can be provided efficiently to facilitate comparison of performance levels of the plurality of systems. In addition, when the evaluation subjects are human translators, translations by different evaluation subjects may be compared to assess their translation skills relative to one another.

According to another embodiment of the present invention, there is provided a translation evaluation method that may be adopted when evaluating the quality of a translation of an original text. The translation evaluation method comprises a parallel translation extraction step in which a basic original text containing a specific evaluation item and a model translation stored in correlation to the basic original text containing the evaluation item are extracted and a translation evaluation step in which translation results obtained by translating the basic original text containing the evaluation item are input and the quality of the translation results is evaluated by comparing the translation results with the model translation corresponding to the basic original text containing the evaluation item.

In the translation evaluation method described above, a basic original text containing a specific evaluation item to be used in the translation evaluation and the model translation corresponding to the basic original text (evaluation set) are extracted, a translation of the basic original text is input and the quality of the translation is evaluated through comparison of the translation and the model translation. Since the translation results obtained by translating the basic original text corresponding to the specific evaluation item are evaluated as a specific evaluation target, an optimal evaluation can be efficiently provided for translation performance verification or translation ability verification. It is to be noted that the specific evaluation item may be input in an evaluation item input step executed separately or it may be set in advance as a fixed value.

According to another embodiment of the present invention, there is provided a computer program enabling a computer to function as a translation evaluation device that evaluates the quality of a translation of an original text. The computer program enables the computer to function as a parallel translation storage unit in which model translations are stored each in correlation with a basic original text used as a translation evaluation basis, an evaluation item input unit to which a specific evaluation item to be used for translation evaluation is input, a parallel translation extraction unit that extracts from the parallel translation storage unit a basic original text containing the evaluation item and a model translation corresponding to the basic original text containing the evaluation item, and a translation evaluation unit that evaluates the quality of translation results constituted with a translated text of the basic original text containing the evaluation item and input thereto, by comparing the translation results with the model translation corresponding to the basic original text containing the evaluation item.

According to the embodiment structured as described above, a computer program enabling a computer to function as the translation evaluation device achieved in an embodiment of the present invention described above is provided. This computer program may be written in any program language. In addition, the computer program may be recorded in any recording medium that is routinely utilized as a program recording medium, e.g., a CD-ROM, a DVD-ROM or a flexible disk, or a medium that may come to be used routinely in the future.

According to the embodiments of the present invention described above, a translation evaluation device, a translation evaluation method and a computer program, with which an optimal evaluation can be efficiently executed for translation performance verification or translation ability verification, are provided.

### BRIEF DESCRIPTION OF THE DRAWINGS

FIG. 1 is a block diagram presenting a structural example for the translation evaluation device achieved in an embodiment;

FIG. 2 shows specific examples of evaluation items used in the embodiment;

FIG. 3 presents a specific example of a structure that may be assumed in the parallel translation database in the embodiment;

FIG. 4 presents a specific example of a structure that may be assumed in the evaluation database in the embodiment;

FIG. 5 presents a flowchart of the evaluation database creation processing executed in the embodiment;

FIG. 6 presents a flowchart of the evaluation processing executed in the embodiment;

FIG. 7 presents specific examples of evaluation items that may be used in a variation; and

FIG. 8 presents a flowchart of the evaluation database creation processing executed in the variation.

### DETAILED DESCRIPTION OF PREFERRED EMBODIMENTS

The following is a detailed explanation of preferred embodiments of the present invention, given in reference to the attached drawings. It is to be noted that in the description and the drawings, the same reference numerals are assigned to components having substantially identical functions and structural features to preclude the necessity for a repeated explanation thereof.

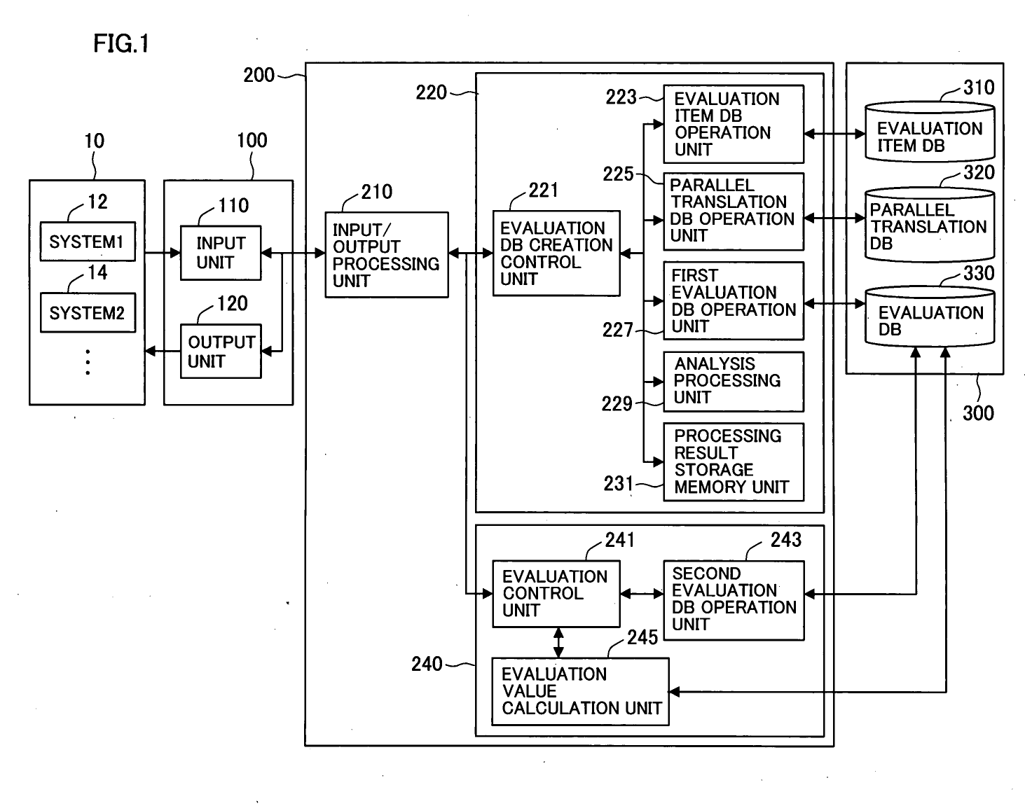

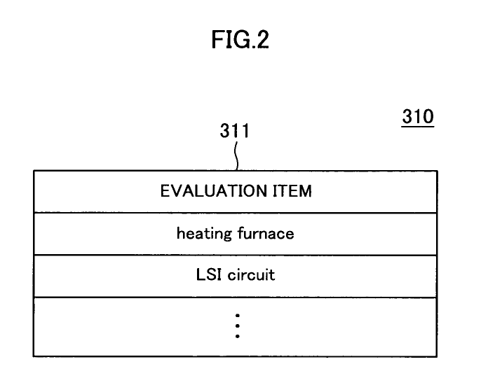

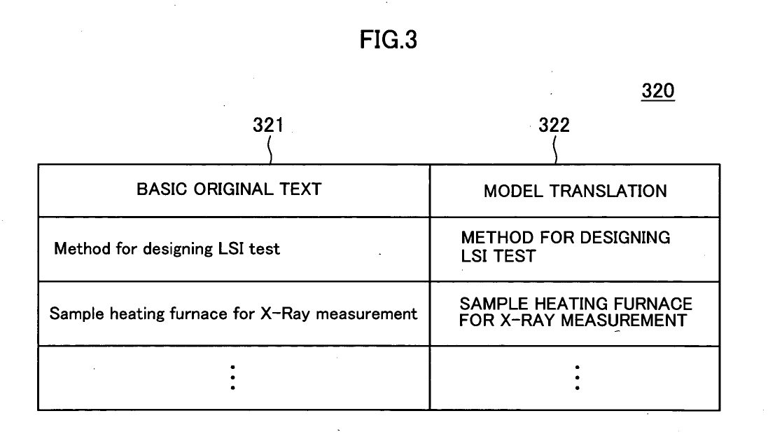

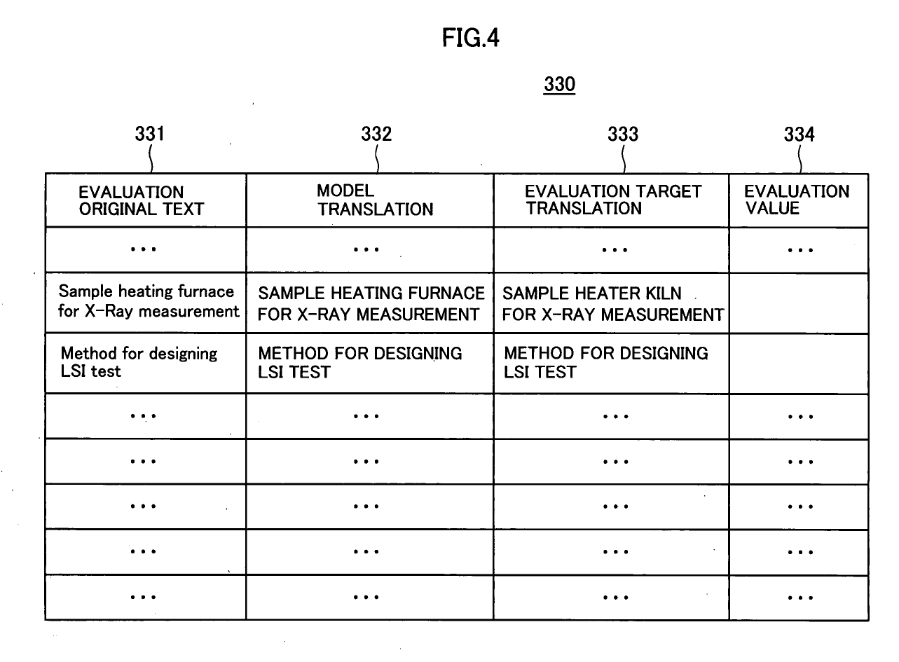

First, in reference to FIGS. 1 through 4, the translation evaluation device achieved in an embodiment of the present invention is described. FIG. 1 is a block diagram presenting a structural example that may be adopted in the translation evaluation device in the embodiment. FIG. 2 presents specific examples of evaluation items that may be used in the embodiment. FIG. 3 presents a specific example of a structure that may be assumed in the parallel translation database in the embodiment and FIG. 4 presents a specific example of a structure that may be assumed in the evaluation database in the embodiment.

Structure of Translation Evaluation Device

As shown in FIG. 1, the translation evaluation device achieved in the embodiment comprises an input/output unit, an evaluation processing unit 200 and a storage unit. The input/output unit 100 is constituted with an input unit 110 and an output unit 120. The input unit 110 is a functional unit by which an evaluation item 331 and an evaluation target translation 333 to be transmitted to the evaluation processing unit 200 or instructions are input. Such an input unit 110 may be constituted with, for instance, a keyboard, a pointing device such as a mouse, a scanner, a microphone or the like. The output unit 120 is a functional unit through which data constituted of characters, images, sound or the like, transmitted from the evaluation processing unit 200, are output. The output unit 120 may be constituted with, for instance, a display device, a printing device or a speaker. It is to be noted that the input/output unit 100 may include a file information input/output unit engaged in operation when inputting/outputting file information or a communication information input/output unit engaged in operation when inputting/outputting communication information through an electrical communication line such as a network.

The evaluation processing unit 200, which is a means for evaluating the quality of the evaluation target translation 333 input through the input/output unit 100, is constituted with an input/output processing unit 210, an evaluation database (DB) creation processing unit 220 and an evaluation processor 240. It is to be noted that in the following description, the term “database” may be abbreviated to “DB”.

The input/output processing unit 210 is a functional unit via which information is input/output between the input/output unit 100 and the evaluation DB creation processing unit 220 and between the input/output unit 100 and the evaluation processor 240.

The evaluation DB creation processing unit 220, which is a functional unit that creates an evaluation DB 330 to be detailed later, is constituted with an evaluation DB creation control unit 221, an evaluation item DB operation unit 223, a parallel translation DB operation unit 225, a first evaluation DB operation unit 227, an analysis processing unit 229 and a processing result storage memory unit 231.

The evaluation DB creation control unit 221 is a functional unit that controls various functional units engaged in operation when creating the evaluation DB 330 to be detailed later. The evaluation DB creation control unit 221 creates the evaluation DB 330 based upon an evaluation DB create instruction for creating the evaluation DB 330, input from the input unit 110 via the input/output processing unit 210. The evaluation DB creation control unit 221 controls the evaluation item DB operation unit 223 so as to store an evaluation item 311 input via the input unit 110 into an evaluation item DB 310 or to obtain an evaluation item 311 from the evaluation item DB 310. The evaluation DB creation control unit 221 also controls the analysis processing unit 229 so as to engage it in analysis of the evaluation item 311. The evaluation DB creation control unit 221 controls the parallel translation DB operation unit 225 so as to search for parallel translation DB information in a parallel translation DB 320 or obtain parallel DB information from the parallel translation DB 320. The evaluation DB creation control unit 221 controls the first evaluation DB operation unit 227 so as to search for evaluation DB information in an evaluation DB 330 or to store evaluation DB information into the evaluation DB 330.

The evaluation item DB operation unit 223 is a functional unit that stores an evaluation item 311 into the evaluation item DB 310 to be detailed later and obtains an evaluation item from the evaluation item DB 310. The evaluation item DB operation unit 223 stores an evaluation item 311, input from the input unit 110 via the input/output processing unit 210, into the evaluation item DB 310, or obtains an evaluation item 311 from the evaluation item DB 310 based upon an instruction issued by the evaluation DB creation control unit 221. The evaluation item DB operation unit 223 transmits the evaluation item 311 that obtained to the evaluation DB creation control unit 221.

The parallel translation DB operation unit 225 is a functional unit that searches for parallel translation DB information stored in the parallel translation DB 320 to be detailed later or obtains parallel translation DB information. The parallel translation DB operation unit 225 searches for parallel DB information containing a basic original text 321 or a model translation 322 and stored in the parallel translation DB 320 or obtains a basic original text 320 and a model translation 322, based upon an instruction provided from the evaluation DB creation control unit 221. The parallel translation DB operation unit 225 transmits the parallel translation DB information search results or the obtained parallel translation DB information to the evaluation DB creation control unit 221.

The first evaluation DB operation unit 227 is a functional unit that searches for evaluation DB information in the evaluation DB 330 to be detailed later and stores evaluation DB information into the evaluation DB 330. Based upon an instruction issued by the evaluation DB creation control unit 221, the first evaluation DB operation unit 227 searches for evaluation DB information containing an evaluation original text 331 (basic original text 321) or a model translation 332 (model translation 322) in the evaluation DB 330, or stores parallel DB information into the evaluation DB 330. The first evaluation DB operation unit 227 transmits the evaluation DB information search results to the evaluation DB creation control unit 221.

The analysis processing unit 229 is a functional unit that executes analysis processing such as morphological analysis or syntax analysis on evaluation items 311 or parallel translation DB information. The analysis processing unit 229 executes morphological analysis or syntax analysis on an evaluation item 311 or parallel translation DB information and generates morphological information or syntax structure information related to the evaluation item 311 or the parallel translation DB information, based upon an instruction issued by the evaluation DB creation control unit 221. The information generated in the analysis processing unit 229 may be, for instance, morphological information that includes information related to a character string, a word type, a conjugation form obtained through the morphological analysis and/or syntax structure information that includes information related to the type of a word constituting a character string or the specific position at which the particular word is placed as obtained through the syntax analysis.

The processing result storage memory unit 231 is a storage unit in which the morphological information or the syntax structure information generated by the analysis processing unit 229 is temporarily stored, and may be constituted with, for instance, a RAM or a flash memory.

The evaluation processor 240 is a functional unit that evaluates the quality of an evaluation target translation 333 input from the input unit 110 via the input/output processing unit 210, and is constituted with an evaluation control unit 241, a second evaluation DB operation unit 243 and an evaluation value calculation unit 245.

The evaluation control unit 241 is a functional unit that controls various function units engaged in operation when evaluating the evaluation target translation 333. The evaluation control unit 241 controls the second evaluation DB operation unit 243 so as to obtain an evaluation original text 331 from the evaluation DB 330 and outputs the evaluation original text 331 that obtained to the output unit 120 via the input/output processing unit 210. It also controls the second evaluation DB operation unit 243 so as to obtain an evaluation original text 331 input from the input unit 110 via the input/output processing unit 210 and an evaluation target translation 333 corresponding to the evaluation original text 331 and then to store the evaluation target translation 333 that obtained into the evaluation DB 330. The evaluation control unit 241 controls the evaluation value calculation unit 245 so as to calculate an evaluation value 334 for the evaluation target translation 333 having been stored into the evaluation DB 330. The evaluation control unit 241 subsequently outputs the evaluation value 334 calculated by the evaluation value calculation unit 245 to the output unit 120 via the input/output processing unit 210.

The second evaluation DB operation unit 243 obtains, for instance, an evaluation original text 331 (basic original text 321) having been stored by the first evaluation DB operation unit 227 into the evaluation DB 330 or stores an evaluation target translation 333 transmitted from the evaluation control unit 241 into the evaluation DB 330. Upon obtaining an evaluation original text 331 and an evaluation target translation 333 from the evaluation control unit 241, the second evaluation DB operation unit 243 matches the evaluation original text 331 obtained from the evaluation control unit 241 with an evaluation original text 331 already stored in the evaluation DB 330 and stores the evaluation target translation 333 into the evaluation DB 330 in correspondence to the evaluation original text 331 already stored in the evaluation DB 330 which has been matched up with the evaluation original text obtained from the evaluation control unit 241.

The evaluation value calculation unit 245 is a functional unit that calculates the evaluation value 334 indicating the quality of the translation. The evaluation value calculation unit 245 calculates the evaluation value 334 indicating the quality of the translation by comparing the evaluation target translation 333 stored in the evaluation DB 330 with the model translation 332 corresponding to the evaluation target translation 333. It is to be noted that the specific method adopted by the evaluation value calculation unit 245 when calculating the evaluation value 334 is to be described in detail later. In addition, the evaluation value calculation unit 245 transmits the evaluation value 334 it has calculated to the evaluation control unit 241.

The storage unit 300 holds the evaluation item DB 310, the parallel translation DB 320 and the evaluation DB 330.

The evaluation item DB 310 is a storage unit in which specific evaluation items 311 to be used to extract specific basic original texts 321 are stored and may be constituted with a memory such as a RAM or a hard disk. In the evaluation item DB 310 achieved in the embodiment, sets of character string information each constituted with at least one word are stored, as shown in FIG. 2. In the evaluation item DB 310 in FIG. 2, character string information “heating furnace” (evaluation item 1) and character string information “LSI circuit” (evaluation item 2) are stored.

The parallel translation DB 320 is a storage unit in which a plurality of pairs of texts each constituted with a basic original text 321 and a model translation 322 set in correlation to each other are stored, and may be constituted with a memory such as a RAM or a hard disk. The parallel translation DB 320 may be constituted with a parallel translation corpus, which is a DB containing samples of texts and translations of the texts provided as digital data. As shown in FIG. 3, basic original texts 321 in a first language (English in this example) and model translations 322 of the basic original texts 321 to a second language (Japanese in this example) are stored in the parallel translation DB 320. In the parallel translation DB 320 in the example presented in FIG. 3, “Method for designing LSI test” (basic original text 1) and “Sample heating furnace for x-ray measurement” (basic original text 2) are stored as the basic original texts 321 and “Method for designing LSI test” (model translation 1) and “Sample heating furnace for x-ray measurement” (model translation 2) are stored as the model translations 322.

The evaluation DB 330 is a storage unit in which information used when evaluating the evaluation target translation 333 is stored and may be constituted with a memory such as a RAM or a hard disk. As shown in FIG. 4, evaluation original texts 331 (basic original texts 321) in the first language, model translations 332 (model translations 322) of the evaluation original texts 331 into the second language, evaluation target translations 333, evaluation values 324 each calculated in correspondence to an evaluation target translation 333, and the like are stored in the evaluation DB 330.

The input/output unit 100, the evaluation processing unit 200 and the storage unit 300 constituting the translation evaluation device may be devices independent of one another or they may be provided as an integrated device. In addition, the functional structures of the individual functional units described above simply represent examples and part of or all of the functional structure of a given functional unit may be incorporated in another functional unit or the functional structure of a given functional unit may be configured as the functional structure of another functional unit, instead.

The structure adopted in the translation evaluation device achieved in the embodiment has been described. The translation evaluation device first creates the evaluation DB 330 prior to the actual evaluation of the evaluation target translation 333 and then calculates the evaluation value 334 for the evaluation target translation 333.

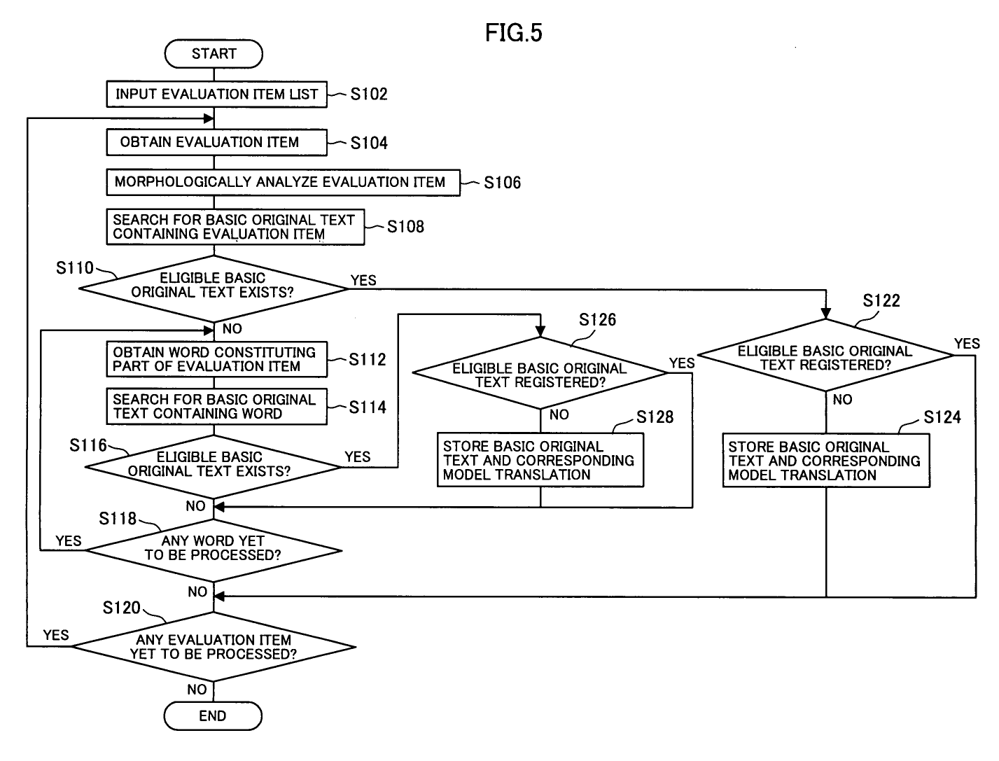

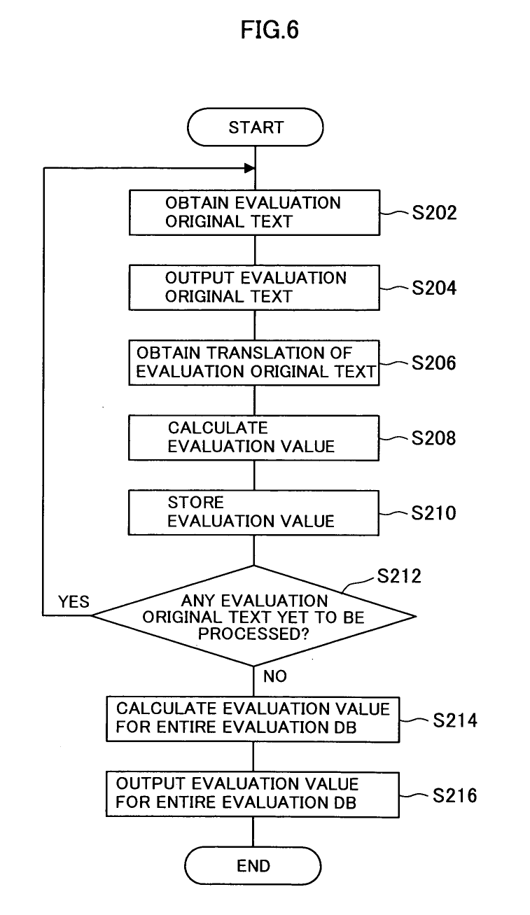

The following is an explanation of the evaluation DB creation processing and the evaluation target translation evaluation processing executed in the embodiment, given in reference to FIGS. 5 and 6. It is to be noted that FIG. 5 presents a flowchart of the evaluation database creation processing executed in the embodiment, whereas FIG. 6 presents a flowchart of the evaluation processing executed in the embodiment.

Evaluation DB Creation Processing

The evaluation DB creation processing is primarily executed by the evaluation DB creation control unit 221. In order to provide the optimal evaluation for system performance verification, a basic original text 321 corresponding to a specific evaluation item 311 and the model translation 322 corresponding to the basic original text 321 are extracted in the evaluation DB creation processing in the embodiment. Namely, the evaluation DB creation processing is executed in order to extract the basic original text 321 corresponding to the specific evaluation item 311 and the model translation 322 corresponding to the basic original text 321.

As shown in FIG. 5, an evaluation item list is first input (S102) following the start of the evaluation DB creation processing. The evaluation item list used in the embodiment may be, for instance, a collection of sets of character string information each constituted with at least one word. The evaluation item list is input to the evaluation DB creation control unit 221 via the input unit 110 and the input/output processing unit 210. The evaluation DB creation control unit 221 controls the evaluation item DB operation unit 233 so as to store the input evaluation item list into the evaluation item DB 310. The evaluation items 311 contained in the evaluation item list are thus stored into the evaluation item DB 310. In the example, the character string information “heating furnace” (evaluation item 1) and the character string information “LSI circuit” (evaluation item 2) in FIG. 2 are input as evaluation items 311.

Once the evaluation item list is input, the evaluation DB creation control unit 221 obtains an evaluation item 311 having been input (S104). The evaluation DB creation control unit 221 controls the evaluation item DB operation unit 223 so as to obtain one of the evaluation items 311 from the evaluation item DB 310. In response, the evaluation item DB operation unit 223 accesses the evaluation item DB 310, obtains one of the evaluation items 311 stored in the evaluation item DB 310 and transmits the obtained evaluation item 311 to the evaluation DB creation control unit 221. In this example, the evaluation item DB creation control unit 221 controls the evaluation item DB operation unit 223 so as to obtain the evaluation item 1 first. It is to be noted that before obtaining the evaluation item 311 from the evaluation item DB 310, the target evaluation item may be checked to determine whether or not it has already been obtained based upon pointer information indicating the acquisition point for the particular evaluation item 311 available at the evaluation item DB 310, or based upon identifier information attached to each evaluation item 311.

Upon obtaining the evaluation item 311, the evaluation DB creation control unit 221 executes morphological analysis on the obtained evaluation item 311 (S106). The evaluation DB creation control unit 221 controls the analysis processing unit 229 so as to morphologically analyze the obtained evaluation item 311. In response, the analysis processing unit 229 executes morphological analysis on the evaluation item 311 transmitted from the evaluation DB creation control unit 221 and transmits morphological information obtained as the analysis results to the evaluation DB creation control unit 221. The evaluation DB creation control unit 221, in turn, temporarily stores the morphological information transmitted from the analysis processing unit into the processing result storage memory unit 231. As a result, the morphological information related to the character string information constituting the evaluation item 311 becomes stored on a temporary basis in the processing result storage memory unit 231. In the example, the analysis processing unit 229 creates morphological information “heat (word type: verb, conjugation form: progressive)” and “furnace (word type: noun, conjugation form: N/A)” in relation to the evaluation item 1 “heating furnace” and transmits the morphological information that generated to the evaluation DB creation control unit 221. The evaluation DB creation control unit 221 then temporarily stores the transmitted morphological information into the processing result storage memory unit 231.

Once the morphological analysis is executed on the evaluation item 311, the evaluation DB creation control unit 221 searches for a basic original text 321 containing the evaluation item 311 (S108). The evaluation DB creation control unit 221 transmits the evaluation item 311 to the evaluation item DB operation unit 233 and also controls the parallel translation DB operation unit 225 so as to search for a basic original text 321 containing the evaluation item 311 having been obtained. In response, the parallel translation DB operation unit 225 accesses the parallel translation DB 320 to search for a basic original text 321 containing the evaluation item 311. In the example, the parallel translation DB operation unit 225 searches for a basic original text 321 containing the evaluation item 1.

It is to be noted that a basic original text 321 “containing the evaluation item 311” as referred to in the description of the embodiment is a basic original text 321 containing words with matching character string information (headers) and matching word types to those of the individual words constituting the evaluation item 311. It is to be noted that a basic original text 321 may be judged to “contain the evaluation item 311” when the character string information in the basic original text 321 alone matches the character string information in the evaluation item 311 or the morphological information corresponding to the basic original text alone matches the morphological information in the evaluation item 311. Alternatively, the decision may be made by judging whether or not any combination of the character string information and a plurality of sets of morphological information (e.g., information related to word types and conjugation forms) corresponding to the evaluation item 311 matches a combination of the character string information and a plurality of types of morphological information corresponding to the basic original text 321.

The morphological information for parallel translation DB information stored in the parallel translation DB 320 may be obtained through morphological analysis executed on a basic original text 321 each time a search is executed, or morphological information generated in advance may be stored together with basic original texts 321 in the parallel translation DB 320 to be referenced at the time of a search. It is to be noted that the following explanation is given by assuming that the morphological information is stored in advance in the parallel translation DB 320.

The evaluation DB creation control unit 221 searching for a basic original text 321 containing the evaluation item 311 verifies the presence of any eligible basic original text 321 containing the evaluation item 311 (S110). The evaluation DB creation control unit 221 controls the parallel translation DB operation unit 225 so as to verify the presence of an eligible basic original text 321. In response, the parallel translation DB operation unit 225 verifies the presence of the eligible basic original text 321 as the parallel translation DB 320 is searched and provides the verification results to the evaluation DB creation control unit 221. It is to be noted that if the presence of an eligible basic original text 320 is verified, the parallel translation DB operation unit 225 transmits the eligible basic original text 321 having been verified to the evaluation DB creation control unit 221 together with the verification results. The evaluation DB creation control unit 221 in the example controls the parallel translation DB operation unit 225 so as to first verify whether or not any basic original text 321 stored in the parallel translation DB 320 contains the evaluation item 1. In the example, the basic original text 2 “Sample heating furnace for x-ray measurement” contains the evaluation item 1 and accordingly, the parallel translation DB operation unit 225 notifies the evaluation DB creation control unit 221 of the presence of an eligible basic original text 321 and also transmits the basic original text 2 to the evaluation DB creation control unit 221.

If the presence of an eligible basic original text 321 is verified in S110, the evaluation DB creation control unit 221 then verifies that the eligible basic original text 321 is registered (S122). The evaluation DB creation control unit 221 controls the first evaluation DB operation unit 227 so as to verify the registration of the eligible basic original text 321. In response, the first evaluation DB operation unit 227 accesses the evaluation DB 330 to verify the registration of an evaluation original text 331 matching the basic original text 321 transmitted from the evaluation DB creation control unit 221 and notifies the evaluation DB creation control unit 221 of the verification results. In this embodiment, the evaluation DB creation control unit 221 controls the first evaluation DB operation unit 227 so as to verify whether or not the evaluation original text 331 corresponding to the basic original text 2 is registered in the evaluation DB 330. Since the evaluation original text 331 matching the basic original text 2 is not registered in the evaluation DB 330, the first evaluation DB operation unit 227 notifies the evaluation DB creation control unit 221 that the basic original text 2 is not yet registered. It is to be noted that evaluation original texts 331, model translations 332 and evaluation target translations 333 are already stored in the evaluation DB 330 shown in FIG. 4.

If the registration of the eligible basic original text 321 is not verified in S122, the evaluation DB creation control unit 221 stores the basic original text 321 as an evaluation original text 331 into the evaluation DB 330 and also stores the corresponding model translation 322 into the evaluation DB 330 as a model translation 332 (S124). If, on the other hand, the registration of the eligible basic original text 321 is verified, the subsequent processing (S120) is executed.

If the registration of the eligible basic original text 321 is not verified, the evaluation DB creation control unit 221 controls the first evaluation DB operation unit 227 so as to store the basic original text 321 and the corresponding model translation 322. In response, the first evaluation DB operation unit 227 accesses the evaluation DB 330 to store the basic original text 321 and the corresponding model translation 322. It is to be noted that the evaluation DB creation control unit 221 controls in advance the parallel translation DB operation unit 225 so as to obtain the model translation 322 corresponding to the basic original text 321 from the parallel translation DB 320. Since the evaluation original text 331 matching the basic original text 2 is not registered in the evaluation DB 330 yet, the evaluation DB creation control unit 221 controls the first evaluation DB operation unit 227 so as to register the basic original text 2 and the corresponding model translation 2 as an evaluation original text 1 and a model translation 1 in the evaluation DB 330 in this example. It is to be noted that the evaluation DB creation control unit 221 controls in advance the parallel translation DB operation unit 225 so as to obtain the model translation 2 corresponding to the basic original text 2.

If the registration of the eligible basic original text 321 is not verified or if the basic original text 321 and the corresponding model translation 322 are stored, the evaluation DB creation control unit 221 executes a verification as to whether or not there is any evaluation item 311 yet to undergo the processing (S120). The evaluation DB creation control unit 221 controls the evaluation item DB operation unit 223 so as to verify the presence of an evaluation item 311 yet to undergo the processing. In response, the evaluation item DB operation unit 223 accesses the evaluation item DB 310 to verify the presence of an unprocessed evaluation item 311 and notifies the evaluation DB creation control unit 221 of the verification results. Since the evaluation item 2 “LSI circuit” is stored in the evaluation item DB 310, the evaluation item DB operation unit 223 notifies the evaluation DB creation control unit 221 that there is an unprocessed evaluation item 311 in this example.

If, on the other hand, there is no unprocessed evaluation item 311, the evaluation DB creation control unit 221 ends the processing for creating the evaluation DB 330. However, if there is an evaluation item 311 yet to undergo the processing, the operation returns to S104 to obtain the next evaluation item 311. In this example, the evaluation item 2 is stored in the evaluation item DB 310. Accordingly, the evaluation item DB operation unit 223 accesses the evaluation item DB 310 to obtain the evaluation item 2 and transmits the obtained evaluation item 2 to the evaluation DB creation control unit 221.

As did the evaluation item 1, the evaluation item 2 then undergoes the processing in S104 through S108 executed by the evaluation DB creation control unit 221. It is to be noted that the evaluation DB creation control unit 221 controls the analysis processing unit 229 in S106 so as to morphologically analyze the obtain evaluation item 2 and transmit the analysis results to the evaluation DB creation control unit 221. The morphological information generated at this time includes “LSI (word type: noun, conjugation form: N/A)” and “circuit word type: noun, conjugation form: N/A)”. The evaluation DB creation control unit 221 then temporarily stores the morphological information transmitted thereto into the processing result storage memory unit 231.

Then in S110, the evaluation DB creation control unit 221 controls the parallel DB operation unit 225 so as to verify the presence of any eligible basic original text 321 containing the evaluation item 2. In this example, the parallel translation DB operation unit 225 first executes a verification as to whether or not the basic original texts 321 stored in the parallel translation DB 320 containing the evaluation item 2. Since neither the basic original text 1 nor the basic original text 2 contains the evaluation item 2, the parallel translation DB operation unit 225 notifies the evaluation DB creation control unit 221 that the presence of a basic original text 321 containing the evaluation item 311 has not been verified.

If the presence of any eligible basic original text 321 is not verified, the evaluation DB creation control unit 221 obtains one of the words constituting the evaluation item 311 (S112). The evaluation DB creation control unit 221 obtains one of the words constituting the evaluation item 311 from the processing result storage memory unit 231 so as to designate it as an evaluation item. In the example, the evaluation DB creation control unit 221 obtains one of the words constituting that evaluation item 2, i.e., “LSI” (word 1). It is to be noted that identifier information appended to each word constituting the evaluation item 311 stored in the processing result storage memory unit 231 may be used when obtaining the word in order to check whether or not that particular word has already been obtained.

After obtaining one of the words constituting the evaluation item 311, the evaluation DB creation control unit 221 controls the parallel translation DB operation unit 225 so as to search for a basic original text 321 containing the word (evaluation item) (S114) as in S108. The parallel translation DB operation unit 225 searches for a basic original text 321 containing the word 1 in the parallel translation DB 320 in this example.

As a basic original text 321 containing the word is searched, the evaluation DB creation control unit 221 controls the parallel translation DB operation unit 225 so as to verify the presence of any eligible basic original text 321 containing the word (evaluation item) (S116) as in S110. In this example, the parallel translation DB operation unit 225 first executes a verification as to whether or not any basic original text 321 stored in the parallel translation DB 320 contains the word 1. Since the basic original text 1 “Method for designing LSI test” contains the word 1, the parallel translation DB operation unit 225 notifies the evaluation DB creation control unit 221 of the presence of a basic original text 321 containing the word 1 and also transmits the basic original text 1 to the evaluation DB creation control unit 221.

If the presence of a basic original text 321 containing the word is verified, the evaluation DB creation control unit 221 controls the first evaluation DB operation unit 227 so as to verify the registration of the eligible basic original text 321 (S126) as in S122. In this example, the first evaluation DB operation unit 227 first executes a verification to ascertain whether or not the basic original text 1 is registered in the evaluation DB 330. Since the basic original text 1 is not registered in the evaluation DB 330, the first evaluation DB operation unit 227 notifies the evaluation DB creation control unit 221 that the basic original text 1 has not been registered yet.

If the registration of the eligible basic original text 321 is not verified in S126, the evaluation DB creation control unit 221 controls the first evaluation DB operation unit 227 so as to store the eligible basic original text 321 and the corresponding model translation 322 into the evaluation DB 330 (S128). If, on the other hand, the presence of the eligible basic original text 321 is verified, the subsequent processing (S118) is executed.

If the registration of the eligible basic original text 321 is not verified, the evaluation DB creation control unit 221 controls the first evaluation DB operation unit 227 so as to store the basic original text 321 and the corresponding model translation 322. Since the evaluation original text 331 matching the basic original text 1 is not registered in the evaluation DB 330 yet, the first evaluation DB operation unit 227 registers the basic original text 1 and the corresponding model translation 1 as an evaluation original text 2 and a model translation 2 in the evaluation DB 330 in this example. It is to be noted that the evaluation DB creation control unit 221 controls in advance the parallel translation DB operation unit 225 so as to obtain the model translation 1 “Method for designing LSI test” corresponding to the basic original text 1 from the parallel translation DB 320.

If the registration of the eligible basic original text 321 is not verified or if the basic original text 321 and the corresponding model translation 322 are stored, the evaluation DB creation control unit 221 executes a verification as to whether or not there is any word (evaluation item) yet to undergo the processing (S118), as in step S120. Since the word 2 “circuit” is stored in the processing result storage memory unit 231, the evaluation item DB creation control unit 221 returns to S112 to obtain the word 2 in this example.

After obtaining the word 2 constituting the evaluation item 311, the evaluation DB creation control unit 221 controls the parallel translation DB operation unit 225, as it did in conjunction with the word 1, so as to search for a basic original text 321 containing the word 2 in the parallel translation DB 320 (S114) and verify the presence of any eligible basic original text 321 containing the word 2 (S116). Since neither the basic original text 1 nor the basic original text 2 contains the word 2, the parallel translation DB operation unit 225 notifies the evaluation DB creation control unit 221 that there is no basic original text 321 containing the word 2. The evaluation DB creation control unit 221 then executes a verification as to whether or not there is any word yet to undergo the processing (S118) and once it is verified that there is no unprocessed word, it ends the evaluation DB creation processing executed in conjunction with the evaluation item 2.

Upon ending the evaluation DB creation processing for the evaluation item 2, the evaluation DB creation control unit 221 controls the evaluation item DB operation unit 223 as it did in conjunction with the evaluation item 1, so as to verify the presence of any evaluation item 311 yet to undergo the processing (S120). Once it is verified that there is no unprocessed evaluation item 311, the evaluation DB creation processing ends.

Through the processing described above, the evaluation original texts 1 and 2 and the corresponding model translations 1 and 2 are stored into the evaluation DB 330 as shown in FIG. 4. It is to be noted that the storage of evaluation target translations 333 is to be described later in reference to the evaluation processing.

Through the evaluation DB creation processing executed in the translation evaluation device in the embodiment, a basic original text 321 corresponding to a specific evaluation item 311 and the model translation 322 corresponding to the basic original text 321 are extracted and an evaluation DB 330 containing the extracted basic original text 321 (evaluation original text 331) and model translation 322 (model translation 332) is created.

In addition, if a basic original text 321 containing the specific evaluation item 311 cannot be extracted, a word constituting part of the evaluation item 311 is designated as an evaluation item and a basic original text 321 containing this word (evaluation item) and the corresponding model translation 322 are extracted. As a result, even when the evaluation item 311 is constituted with numerous words and a basic original text 321 containing all the words constituting the evaluation item 311 cannot be extracted, a basic original text 321 containing at least one of the words can be extracted.

It is to be noted that through the evaluation DB creation processing, a basic original text 321 containing the evaluation item 311 and constituted with a predetermined number of words and the model translation 322 corresponding to this basic original text 321 may be stored into the evaluation DB 330. Since the optimal number of words can be set in correspondence to specific purposes of evaluation by, for instance, setting a smaller number of words when evaluating the accuracy of the translation of the individual words or setting a greater number of words when evaluating the fluency of the translation of a sentence, the optimal basic original text 321 and model translation 322 to be used for reference can be extracted efficiently.

It is also to be noted that during the evaluation DB creation processing, syntax analysis may be executed on the evaluation item 311 and the parallel translation DB information as well as or in place of the morphological analysis. In such a case, the translation (evaluation target translation 333) of a basic original text 321 corresponding to the syntax structure information (e.g., information regarding the type of word constituting a character string or the specific position at which the particular type of word is placed) in the specific evaluation item 311 is evaluated, an optimal evaluation can be provided with efficiency for system performance verification.

Evaluation Processing

Next, the evaluation processing executed to evaluate an evaluation target translation 333 by using the evaluation DB 330 having been created as described above is explained.

Immediately following the start of the evaluation processing, an evaluation original text 331 is first obtained (S202) as shown in FIG. 6. The evaluation control unit 241 controls the second evaluation DB operation unit 243 so as to obtain one of the evaluation original texts 331 in the evaluation DB 330. In response, the second evaluation DB operation unit 243 accesses the evaluation DB 330 and obtains one of the evaluation original texts 331 stored in the evaluation DB 330. The second evaluation DB operation unit 243 obtains the evaluation original text 1 “Sample heating furnace for x-ray measurement” in this example. It is to be noted that before obtaining the evaluation, original text 331 from the evaluation DB 330, the target evaluation original text may be checked to determine whether or not it has already been obtained based upon pointer information indicating the acquisition point for the particular evaluation original text available at the evaluation DB 330 or based upon identifier information attached to each evaluation original text 331.

Once an evaluation original text 331 is obtained, the evaluation control unit 241 outputs the obtained evaluation original text 331 to an external system 10 such as a machine translation system (an external system 12 in the embodiment) (S204). The evaluation control unit 241 outputs the obtained evaluation original text 331 to the external system 12 via the input/output processing unit 210 and the output unit 120. In this example, the evaluation control unit 241 first outputs the evaluation original text 1 having been obtained to the external system 12.

Upon outputting the obtained evaluation original text 331 to the external system 12, the evaluation control unit 241 obtains the evaluation original text 331 and a corresponding evaluation target translation 333 from the external system 12 (S206). The evaluation control unit 241 obtains the evaluation original text 331 and the translation of the evaluation original text 331 (evaluation target translation 333) transmitted from the external system 12 via the input unit 110 and the input/output processing unit 210. The evaluation control unit 241 then controls the second evaluation DB operation unit 243 so as to store the obtained evaluation target translation 333 into the evaluation DB 330. In response, the second evaluation DB operation unit 243 first obtains the evaluation original text 331 and the evaluation target translation 333 from the evaluation control unit 241. The second evaluation DB operation unit 243 then accesses the evaluation DB 330, searches for the evaluation original text 331 in the evaluation DB 330 and stores the evaluation target translation 333 obtained in correspondence to this evaluation original text 331. In this example, the evaluation control unit 241 stores an evaluation target translation 1 “Sample heater kiln for x-ray measurement” (in Japanese) as the evaluation target translation 333 corresponding to the evaluation original text 1.

Upon obtaining the evaluation target translation 333 from the external system 12, the evaluation control unit 241 calculates an evaluation value 334 for the evaluation target translation 333 (S208). The evaluation control unit 241 first controls the second evaluation DB operation unit 243 so as to obtain the evaluation target translation 333 and the corresponding model translation 332 stored in the evaluation DB 330. The evaluation control unit 241 then transmits the evaluation target translation 333 and the model translation 332 having been obtained by the second evaluation DB operation unit 243 to the evaluation value calculation unit 245 and controls the evaluation value calculation unit 245 so as to calculate the evaluation value 334 for the evaluation target translation 333. Subsequently, the evaluation control unit 241 obtains the calculated evaluation value 334 from the evaluation value calculation unit 245. In this example, the evaluation control unit 241 obtains the evaluation value 334 calculated for the evaluation target translation 1 corresponding to the evaluation original text 1 based upon its model translation 1 “Sample heating furnace for x-ray measurement” (in Japanese). It is to be noted that the evaluation value 334 for the evaluation target translation 333 may be calculated by adopting an evaluation value calculation method in the related art such as either of those disclosed in non-patent reference literature 2 and non-patent reference literature 3.

Once the evaluation value 334 for the evaluation target translation 333 is calculated, the evaluation control unit 241 stores the calculated evaluation value 334 (S210). The evaluation control unit 241 stores the calculated evaluation value 334 into the evaluation DB 330 in correspondence to the evaluation target translation 333. In this example, the evaluation control unit 241 stores the calculated evaluation value 334 into the evaluation DB 330 in correspondence to the evaluation target translation 1.

After storing the calculated evaluation value 334, the evaluation control unit 241 executes a verification to ascertain whether or not there is an evaluation original text 331 yet to undergo the processing (S212). The evaluation control unit 241 controls the second evaluation DB operation unit 243 so as to verify the presence of any unprocessed evaluation original text 331. In response, the second evaluation DB operation unit 243 accesses the evaluation DB 330 to verify the presence of an evaluation original text 331 yet to undergo the processing. In this example, the evaluation original text 2 “Method for designing LSI test” is stored in the evaluation DB 330, and accordingly, the second evaluation DB operation unit 243 notifies the evaluation control unit 241 that there is an evaluation original text 331 yet to undergo the processing.

If there is no more unprocessed evaluation original text 331, the evaluation control unit 241 executes the subsequent processing (S214), whereas if there is an evaluation original text 331 yet to be processed, the operation returns to S202, in which the evaluation control unit 241 controls the second evaluation DB operation unit 243 so as to obtain the next evaluation original text 331. In this example, the evaluation original text 2 is stored in the evaluation DB 330, and, accordingly, the second evaluation DB operation unit 243 accesses the evaluation DB 330 to obtain the evaluation original text 2 and then transmits the obtained evaluation original text 2 to the evaluation control unit 241.

The evaluation control unit 241 executes the processing in S204 through S210 for the evaluation original text 2, as it did for the evaluation original text 1. It is to be noted that in S208, the evaluation control unit 241 obtains an evaluation value 334 calculated for the evaluation target translation 2 “Method for designing LSI test” (in Japanese) corresponding to the evaluation original text 2 based upon the model translation 2 “Method for designing LSI test” (in Japanese).

Then, in S212, the evaluation control unit 241 controls the second evaluation DB operation unit 243 so as to verify the presence of any evaluation original text 331 yet to undergo the processing. In the example, there is no evaluation original text 331 other than the evaluation original texts 1 and 2 stored in the evaluation DB 330, and accordingly, the second evaluation DB operation unit 243 notifies the evaluation control unit 241 that there is no evaluation original text 331 yet to undergo the processing.

Upon verifying that there is no more evaluation original text 331 yet to undergo the processing, the evaluation control unit 241 calculates an evaluation value for the entire evaluation DB 330. The evaluation control unit 241 controls the second evaluation DB operation unit 243 so as to obtain the evaluation values 334, each calculated in correspondence to one of the evaluation target translations 333 from the evaluation DB 330 where they are stored. Then, based upon the evaluation values 334 for the individual evaluation target translations 333 obtained via the second evaluation DB operation unit 243, the evaluation value for the entire evaluation DB 330 is calculated as the total sum or the average of the evaluation values 334.

Once the evaluation value for the entire evaluation DB 330 is calculated, the evaluation control unit 241 outputs the evaluation value for the entire evaluation DB 330 (S216). The evaluation control unit 241 outputs the evaluation value calculated for the entire evaluation DB 330 to the external system 12 via the input/output processing unit 210 and the output unit 210. Once the evaluation value for the entire evaluation DB 330 is output, the evaluation control unit 241 ends the evaluation processing.

Through the evaluation processing executed in the translation evaluation device in the embodiment, the evaluation values 334 for evaluation target translations 333 are calculated by using the evaluation DB 330 having been created through the evaluation DB creation processing. Thus, the evaluation value for the entire evaluation DB 330 is calculated by using evaluation target translations 333 corresponding to specific evaluation items 311 so as to provide an optimal evaluation with a high level of efficiency for system performance verification.

It is to be noted that evaluation target translations 333 and 333′ obtained from a plurality of external systems 12 and 14 may be stored into the evaluation DB 330 and the plurality of evaluation target translations 333 and 333′ may be simultaneously compared with the model translation 332 so as to execute evaluation processing to evaluate the evaluation target translations 333 and 333′ originating from the plurality of external systems 12 and 14. In this case, an optimal evaluation can be provided efficiently for system performance comparison of the external systems 12 and 14 with different specifications or for the external systems 12 and 14 with one assuming pre-update specifications and the other assuming updated specifications.

It is to be noted that an evaluation original text 331 (basic original text 321) does not need to have an absolute one-to-one correspondence with a single model translation 332 (model translation 322) and that a plurality of model translations 332 (model translations 322) may be set in correspondence to a given evaluation original text 331 (basic original text 321). In such case, evaluation values 334 may be calculated for an evaluation target translation 333 by calculating an evaluation value 334 in correspondence to each model translation 333 and then taking on the highest value (or the lowest value) among the evaluation values 334 that calculated or calculating the average of the evaluation values 334.

It is also to be noted that during the evaluation processing executed on the evaluation target translations 333, a plurality of evaluation original texts 331 may be processed in a batch instead of processing one evaluation original text 331 stored in the evaluation DB 330 at a time.

In the translation evaluation device achieved in the embodiment by adopting the translation evaluation method described above, an evaluation set made up with a basic original text 321 containing a specific evaluation item 311 to be used in the translation evaluation and the model translation 322 corresponding to the basic original text 321 is extracted, and the quality of a translation (evaluation target translation 333) of the basic original text 321 is evaluated through comparison of the translation and the model translation 332. Since the translation results (evaluation target translation 333) obtained by translating the basic original text 321 corresponding to the specific evaluation item 311 are set as the evaluation target, an optimal evaluation can be efficiently provided for translation performance verification or translation ability verification.

Variation of Translation Evaluation Method

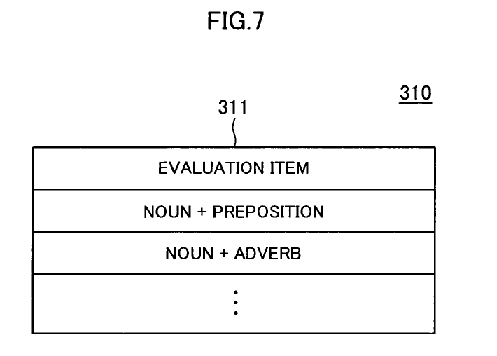

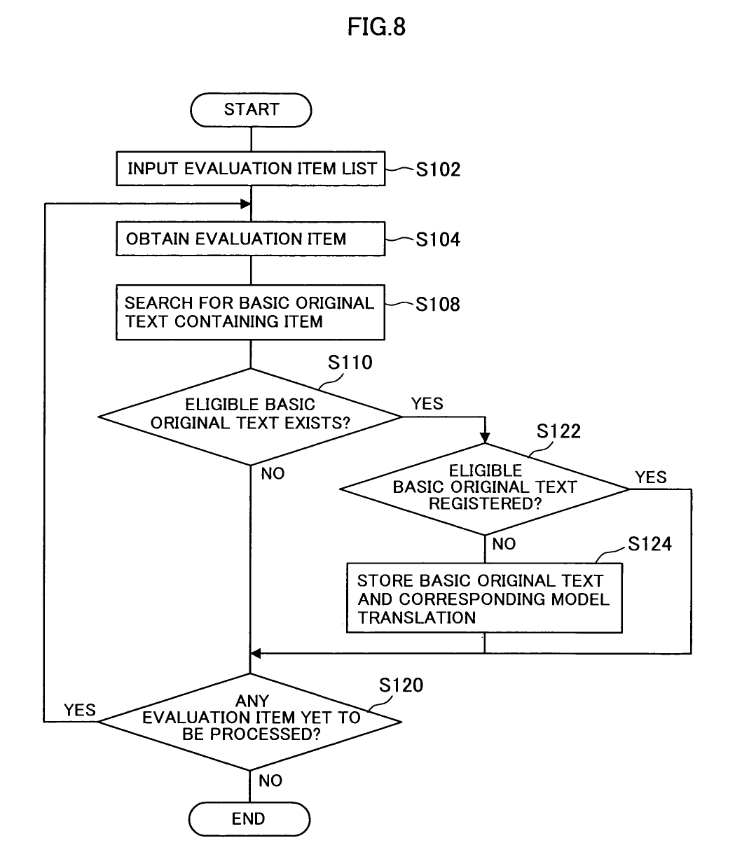

In reference to FIGS. 7 and 8, a translation evaluation method achieved as a variation of the embodiment of the present invention is described. It is to be noted that FIG. 7 presents specific examples of evaluation items that may be used in the variation. FIG. 8 presents a flowchart of the evaluation DB creation processing executed in the variation. In the description of the translation evaluation method achieved in the variation, features identical to those of the embodiment of the present invention having already been described are not explained.

Evaluation DB Creation Processing

As shown in FIG. 8, immediately after the evaluation DB creation processing starts, an evaluation item list is input (S102). The variation differs from the embodiment in that evaluation items 311 constituted of morphological information alone instead of character string information related to character strings constituting words are used. The following explanation is given on an example in which morphological information “noun+preposition” (evaluation item 1) and morphological information “noun+adverb” (evaluation item 2) are input as evaluation items 311, as shown in FIG. 7.

Once the evaluation item list is input, the evaluation DB creation control unit 221 obtains an evaluation item 311 having been input (S104). In this variation, the evaluation DB creation control unit 221 first obtains the evaluation item 1 via the evaluation item DB operation unit 223.

Upon obtaining the evaluation item 311, the evaluation DB creation control unit 221 searches for a basic original text 321 containing the evaluation item 311 (S108). In the variation, the evaluation DB creation control unit 221 searches for a basic original text 321 containing the evaluation item 1 via the parallel translation DB operation unit 225. It is to be noted that a basic original text 321 “containing the evaluation item 311” in this context refers to a basic original text 321 containing morphological information matching the morphological information (word types) constituting the evaluation item 311.

The evaluation DB creation control unit 221 searching for a basic original text 321 containing the evaluation item 311 verifies the presence of any eligible basic original text 321 containing the evaluation item 311 (S110). In this variation, the evaluation DB creation control unit 221 first executes a verification via the parallel translation DB operation unit 225 as to whether or not a basic original text 321 stored in the parallel translation DB 320 shown in FIG. 3 contains the evaluation item 1. Since the evaluation item 1 has matches in the parts “Method for” and “furnace for” in the basic original text 1 “Method for designing LSI test” and the basic original text 2 “Sample heating furnace for x-ray measurement” respectively, the parallel translation DB operation unit 225 notifies the evaluation DB creation control unit 221 that basic original texts 321 with parts thereof matching the evaluation item 1 are present and also transmits the basic original texts, 1 and 2.

If the presence of any eligible basic original text 321 is verified in S110, the evaluation DB creation control unit 221 executes a verification to ascertain whether or not the eligible basic original text 321 is registered (S122). In the variation, the evaluation DB creation control unit 221 first executes a verification via the first evaluation DB operation unit 227 to ascertain whether or not evaluation original texts 331 equivalent to the basic original texts 1 and 2 are registered in the evaluation DB 330. Since evaluation original texts 331 corresponding to the basic original texts 1 and 2 are not registered in the evaluation DB 330, the first evaluation DB operation unit 227 notifies the evaluation DB creation control unit 221 that neither the basic original text 1 nor the basic original text 2 has been registered.

If the registration of the eligible basic original texts 321 is not verified in S110, the evaluation DB creation control unit 221 stores the basic original texts 321 as the evaluation original text 331 into the evaluation DB 330 and also stores the corresponding model translations 322 into the evaluation DB 330 via the first evaluation DB operation unit 227 (S124). If, on the other hand, the registration of the eligible basic original texts 321 is verified, the subsequent processing (S120) is executed.

Since evaluation original texts 331 corresponding to the basic original text 1 and the basic original text 2 are not registered in the evaluation DB 330, the first evaluation DB operation unit 227 stores the basic original texts 1 and 2 and the corresponding model translations 1 and 2 into the evaluation DB 330 as evaluation original texts 1 and 2 and model translations 1 and 2 in the variation. It is to be noted that the evaluation DB creation control unit 221 controls the parallel translation DB operation unit 225 in advance so as to obtain the model translations 1 and 2 corresponding to the basic original texts 1 and 2.

If the registration of the eligible basic original texts 321 is not verified or if the basic original texts 321 and the corresponding model translations 322 are stored, the evaluation DB creation control unit 221 executes a verification as to whether or not there is any evaluation item 311 yet to undergo the processing (S120). If there is no unprocessed evaluation item 311, the evaluation DB creation control unit 221 ends the evaluation DB creation processing. However, if there is an evaluation item 311 yet to undergo the processing, the evaluation DB creation control unit 221 returns to S104 to control the evaluation item DB operation unit 223 so as to obtain the next evaluation item 311. In this variation, the evaluation item 2 is stored in the evaluation item DB 310 and, accordingly, the evaluation item DB operation unit 223 notifies the evaluation DB creation control unit 221 that there is an evaluation item 311 yet to be processed.

The evaluation DB creation control unit 221 obtains the evaluation item 2 via the evaluation item DB operation unit 223 (S104). Upon obtaining the evaluation item 311, the evaluation DB creation control unit 221 searches for any basic original text 321 containing the evaluation item 2 via the parallel translation DB operation unit 225 (S108).

While searching for a basic original text 321 containing the evaluation item 311, the evaluation DB creation control unit 221 executes a verification via the parallel translation DB operation unit 225 as to whether or not a basic original text 321 stored in the parallel translation DB 320 contains the evaluation item 2 (S110). Since neither the basic original text 1 nor the basic original text 2 contains the evaluation item 2, the parallel translation DB operation unit 225 notifies the evaluation DB creation control unit 221 that there is no basic original text 321 containing the evaluation item 311.

Since the presence of any basic original text 321 containing the evaluation item 2 has not been verified, the evaluation DB creation control unit 221 verifies the presence of any evaluation item 311 yet to be processed via the evaluation item DB operation unit 223 (S120). Since there is no evaluation item 311 other than the evaluation items 1 and 2 stored in the evaluation item DB 310, the evaluation DB creation control unit 211 ends the evaluation DB creation processing upon verifying that there is no more evaluation item 311 to undergo the processing.

Through the evaluation DB creation processing executed by adopting the translation evaluation method in the variation, a basic original text 321 corresponding to a specific evaluation item 311 and the model translation 322 corresponding to the basic original text 321 are extracted and an evaluation DB 330 containing the extracted basic original text 321 (evaluation original text 331) and the model translation 322 (model translation 332) is created. The variation is particularly ideal in applications in which any improvements in the system performance needs to be verified after a translation algorithm related to a specific grammatical rule (e.g., a rule related to a word type or a conjugation form) is modified in the system.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

For instance, the present invention has been described in reference to the embodiment and the variation by assuming that an external system, e.g., the external systems 12 and 14, such as a machine translation system, is the evaluation subject. However, the present invention is not limited to this example and may be adopted equally effectively when a human translator is the evaluation subject. By adopting the present invention when evaluating the translation ability of the human subject (evaluation subject), the translation ability of the evaluation subject can be evaluated accurately and efficiently in correspondence to specific evaluation items.

In addition, an explanation is given above in reference to the embodiment on an example in which the combination of character string information and a grammatical rule (i.e., “character string information” AND “grammatical rule”) is set as an evaluation item 311. However, the present invention is not limited to this example and it may be equally effectively adopted when “character string information” OR “grammatical rule” is set as an evaluation item 311 or “character string information” AND “grammatical rule 1,” OR “grammatical rule 2” is set as an evaluation item 311. By setting optimal evaluation items 311 to suit specific purposes of evaluation, the translation performance or the translation ability can be evaluated even more accurately and efficiently.

1. A translation evaluation device that evaluates the quality of a translation of an original text, comprising:
a parallel translation storage unit in which basic original texts used as a basis for translation evaluation and correlated model translations used as models for translation of the basic original texts are stored;
an evaluation item input unit to which a specific evaluation item to be used for translation evaluation is input;
a parallel translation extraction unit that extracts from said parallel translation storage unit a basic original text containing said evaluation item and a model translation corresponding to said basic original text containing said evaluation item; and
a translation evaluation unit that evaluates the quality of translation results constituted with a translation of said basic original text containing said evaluation item and input thereto, by comparing said translation results with said model translation corresponding to said basic original text containing said evaluation item.

2. A translation evaluation device according to claim 1, wherein:
said evaluation item includes information related to at least one grammatical rule.

3. A translation evaluation device according to claim 1, wherein:
the evaluation item includes character string information constituted with at least one word.

4. A translation evaluation device according to claim 3, wherein:
if a basic original text containing said evaluation item cannot be extracted, said parallel translation extraction unit regards a word constituting part of the evaluation item as said evaluation item and extracts a basic original text containing said evaluation item and a model translation corresponding to said basic original text containing said evaluation item.

5. A translation evaluation device according to claim 3, further comprising:
a morphological analysis unit that morphologically analyzes said evaluation item and said basic original text, wherein:
said parallel translation extraction unit extracts a basic original text containing morphological information identical to morphological information carried in said evaluation item and a model translation corresponding to said basic original text containing morphological information identical to the morphological information in said evaluation item.

6. A translation evaluation device according to claim 3, further comprising:
a syntax analysis unit that executes syntax analysis of said evaluation items and said basic original text, wherein:
said parallel translation extraction unit extracts a basic original text containing syntax structure information identical to syntax structure information in said evaluation item and a model translation corresponding to said basic original text containing syntax structure information identical to the syntax structure information in said evaluation item.

7. A translation evaluation device according to claim 3, wherein:
the number of words constituting said basic original text to be extracted for the translation evaluation is input at the evaluation item input unit; and
said parallel translation extraction unit extracts a basic original text containing said evaluation item and constituted with words, the number of which matches the number of words having been input, and a model translation corresponding to said basic original text containing said evaluation item and constituted with the matching number of words.

8. A translation evaluation device according to claim 1, wherein:
said evaluation item is input to said evaluation item input unit as an evaluation item data file containing a plurality of evaluation items.

9. A translation evaluation device according to claim 1, wherein:
in said parallel translation storage unit, morphological information and/or syntax structure information related to each basic original text is stored in correlation to said basic original text.

10. A translation evaluation device according to claim 1, wherein:
said translation evaluation unit compares a plurality of sets of translation results obtained by translating a basic original text containing said evaluation item with said model translation corresponding to said basic original text containing said evaluation item.

11. A translation evaluation method for evaluating the quality of a translation of an original text, comprising:
a parallel translation extraction step in which a basic original text containing a specific evaluation item and a model translation stored in correlation to said basic original text containing said evaluation item to be used for reference are extracted; and
a translation evaluation step in which translation results obtained by translating said basic original text containing said evaluation item are input and the quality of the translation results is evaluated, by comparing the translation results with said model translation corresponding to said basic original text containing said evaluation item.

12. A translation evaluation method according to claim 11, further comprising:
an evaluation item input step in which said evaluation item to be used for translation evaluation is input.

13. A translation evaluation method according to claim 11, wherein:
said evaluation items includes information related to at least one grammatical rule.

14. A translation evaluation method according to any of claims 11, wherein:
said evaluation item includes character string information constituted with at least one word.

15. A translation evaluation method according to claim 14, wherein:
if a basic original text containing said evaluation item cannot be extracted, a word constituting part of said evaluation item is regarded as an evaluation item and a basic original text containing said evaluation item and a model translation corresponding to said basic original text containing said evaluation item are extracted in said parallel translation extraction step.

16. A translation evaluation method according to claim 14, further comprising:
a morphological analysis step in which said evaluation item and said basic original text are morphologically analyzed, wherein:
a basic original text containing morphological information identical to morphological information in said evaluation item and a model translation corresponding to said basic original text containing morphological information identical to the morphological information in said evaluation item are extracted in said parallel translation extraction step.

17. A translation evaluation method according to claim 14, further comprising:
a syntax analysis step in which said evaluation item and said basic original text is syntactically analyzed, wherein:
a basic original text containing syntax structure information identical to syntax structure information in said evaluation item and a model translation corresponding to said basic original text containing syntax structure information identical to the syntax structure information in said evaluation item are extracted in said parallel translation extraction step.

18. A translation evaluation method according to claim 14, further comprising:
a step of inputting the number of words constituting said basic original text to be extracted for translation evaluation, wherein:
a basic original text, containing said evaluation item and constituted with words, the number of which matches the number of words having been input, and a model translation corresponding to said basic original text containing said evaluation item and constituted with the matching number of words, are extracted in said parallel translation extraction step.

19. A translation evaluation method according to claim 12, wherein:
said evaluation item is input as an evaluation item data file containing a plurality of evaluation items.

20. A translation evaluation method according to claim 11, further comprising:
a step of storing morphological information and/or syntax structure information for said basic original text in correlation to said basic original text.

21. A translation evaluation method according to claim 11, wherein:
a plurality of sets of translation results obtained by translating a basic original text containing said evaluation item are compared with said model translation corresponding to said basic original text containing said evaluation item in said translation evaluation step.

22. A computer program enabling a computer to function as a translation evaluation device that evaluates the quality of a translation of an original text, which enables said computer to function as;
a parallel translation storage unit in which basic original texts used as a basis for translation evaluation and correlated model translations used as models for translation of the basic original texts are stored;
an evaluation item input unit to which a specific evaluation item to be used for translation evaluation is input;
a parallel translation extraction unit that extracts from said parallel translation storage unit a basic original text containing said evaluation item and a model translation corresponding to said basic original text containing said evaluation item; and
a translation evaluation unit that evaluates the quality of translation results constituted with a translated text of said basic original text containing said evaluation item and input thereto, by comparing said translation results with said model translation corresponding to said basic original text containing said evaluation item.
